(19) United States
(12) Patent Application Publication
(10) Pub. No.: US 2016/0215112 A1
(43) Pub. Date: Jul. 28, 2016

(54) ENHANCED FOAM RESIN

(71) Applicant: NOVA Chemicals (International) S.A., Fribourg (CH)

(72) Inventors: Chris Hung, Calgary (CA); Paige Fielding, Medina, OH (US)

(73) Assignee: NOVA CHEMICALS (INTERNATIONAL) S.A., Fribourg (CH)

(21) Appl. No.: 14/603,716

(22) Filed: Jan. 23, 2015

(51) Int. Cl. C08J 9/00; C08J 9/14; C08L 23/06

(52) U.S. Cl. CPC C08J 9/0061; C08L 23/06; C08J 9/141; C08J 2201/03; C08J 2203/14; C08J 2323/06; C08J 2423/08; C08L 2205/02

(57) ABSTRACT

Blends of a single site catalyzed polyethylene copolymer and a low density homopolymer having a melt strength from about 2.5 to about 8.0 cN as determined by the Rosand Constant Haul Off method, a melt index of less than 10 g/10 minute and a flexural modulus between about 206 MPa (30,000 psi) and about 620 MPa (90,000 psi) are suitable for use in the manufacture of foams.

### FIELD OF DISCLOSURE

The present disclosure relates to blends of polyethylene that have an enhanced melt strength and are useful in the manufacture of foams and planks having improved properties.

### BACKGROUND OF DISCLOSURE

The use of single site catalyzed polyethylene in blends for foam applications has been taught since at least as early as 1990's, e.g., U.S. Pat. Nos. 5,288,762; 5,340,840; 5,369,136; 5,387,620; and 5,407,965 all in the name of Park assigned to The Dow Chemical Company. These patents disclose foams which are blends of substantially linear polyethylene (e.g., have long chain branches and/or improved rheology) with other ethylenic polymers. The foams are typically crosslinked. The blends of the present disclosure include single site polymer which do not contain long chain branches. In some embodiments the foams of the present disclosure are not crosslinked.

U.S. Pat. Nos. 6,545,094 and 6,723,793, having an earliest filing date of Aug. 9, 2001 in the name of Oswald assigned to Dow Global Technologies Inc., teach polyethylene blends of single site catalyzed linear polyethylene resin (i.e., it has no long chain branches) with low density polyethylene. The blend has a flex modulus of lower than 30,000 psi or greater than 100,000 psi. The blends of the present disclosure have a flexural modulus between 30,000 and 100,000 psi.

U.S. Pat. No. 6,096,793, issued Aug. 1, 2000 from an application filed Dec. 22, 1998 in the name of Lee at al., assigned to Sealed Air Corporation, discloses a foam of a blend of polyethylenes, the blend having a melt flow index (I₂ 2.16 kg and 190° C.) greater than 10 g/10 minutes. The blends of the present disclosure comprise a LDPE and a LLDPE having a melt flow index (I₂ 2.16 kg 190° C.) of less than 10 g/10 minutes.

U.S. Pat. No. 7,173,069 (corresponds to GB Patent No. 2,395,948) issued Feb. 6, 2007, from an application filed Dec. 4, 2003 in the name of Swennen, assigned to Pregis Innovative Packaging Inc., teaches blending a Ziegler Natta catalyzed polyethylene resin with a high pressure low density polyethylene resin wherein the difference in maximum crystallization peak between the two resins is greater than 8° C. The blends of the present disclosure have a difference in maximum crystallization peak between the two resins is less than 6° C. Additionally, the blends do not contain a Ziegler Natta resin.

The present disclosure seeks to provide a resin blend of a single site catalyzed polyethylene and a high pressure low density polyethylene resin having an improved melt strength. The resin blend is suitable for use in the production of foams.

### SUMMARY OF DISCLOSURE

One embodiment of the present disclosure seeks to provide a polyethylene foam having a density from about 10 kg/m³ (about 0.6 pounds per cubic foot (pcf)) to about 20 kg/m³ (about 1.25 pcf) comprising a blend of polyethylene polymers comprising:

from about 90 to about 60 weight % of polyethylene homopolymer prepared in a high pressure process having a density from about 0.915 to about 0.920 g/cc, a melt index from about 0.70 to about 4.5 g/10 min (at 2.16 kg/190° C.), a maximum melting temperature from (DSC) about 105° C. to about 112° C.; a maximum crystallization temperature from about 95° C. to about 100° C.; a melt strength from about 2.0 to about 7.0 cN as determined by the Rosand Constant Haul Off method; and

from about 10 to about 40 weight % of a single site catalyzed polyethylene copolymer having a density from about 0.915 to about 0.918 g/cc; a melt index from about 0.60 to about 1.2 g/10 min (at 2.16 kg/190° C.); a maximum melting temperature (DSC) from about 108° C. to about 112° C.; a maximum crystallization temperature (DSC) within 6° C. of that of component i); a flexural modulus between 206 MPa (30,000 psi) and 620 MPa (90,000 psi), and a melt strength from about 1 to about 2 cN as determined by the Rosand Constant Haul Off method;

said blend having a melt strength from about 2.50 to about 8.0 cN as determined by the Rosand Constant Haul Off method, a melt index of less than 10 g/10 minute and a flexural modulus between 206 MPa (30,000 psi) and 620 MPa (90,000 psi).

In a further embodiment, component ii) is a copolymer of from about 98 to about 85 wt. % of ethylene and the balance one or more C₄₋₈ alpha olefins.

In a further embodiment, the difference in maximum melting temperature for components i) and ii) is 4° C. or less.

In a further embodiment, the difference between the maximum crystallization temperature of the components is less than 4° C.

In a further embodiment, component ii) comprises from about 98 to about 93 weight % of ethylene.

In a further embodiment, component ii) is an ethylene octene copolymer.

In a further embodiment, the foam has a density from about 0.8 pcf (about 12.8 kg/m³) to about 1.20 pcf (about 19.2 kg/m³)

A further embodiment provides a blend of polyethylene polymers comprising:

from about 90 to about 60 weight % of polyethylene homopolymer prepared in a high pressure process having a density from about 0.915 to about 0.920 g/cc, a melt index from about 0.70 to about 4.5 g/10 min (at 2.16 kg/190° C.), a maximum melting temperature from (DSC) about 105° C. to about 112° C.; a maximum crystallization temperature from about 95° C. to about 100° C.; a melt strength from about 2.0 to about 7.0 cN as determined by the Rosand Constant Haul Off method; and

from about 10 to about 40 weight % of a single site catalyzed polyethylene copolymer having a density from about 0.915 to about 0.918 g/cc; a melt index from about 0.60 to about 1.2 g/10 min (at 2.16 kg/190° C.); a maximum melting temperature (DSC) from about 108° C. to about 112° C.; a maximum crystallization temperature (DSC) within 6° C. of that of component i); a flexural modulus between 206 MPa (30,000 psi) and 620 MPa (90,000 psi), and a melt strength from about 1 to about 2 cN as determined by the Rosand Constant Haul Off method;

said blend having a melt strength from about 2.5 to about 8.0 cN as determined by the Rosand Constant Haul Off method, a melt index of less than about 10 g/10 minute and a flexural modulus between 206 MPa (30,000 psi) and 620 MPa (90,000 psi).

A further embodiment provides a process for making the above polyethylene foam comprising passing the above polyethylene blend through an extruder at a temperature above the melting point of the blend and injecting from about 2 to about 25 weight % of a blowing agent into the blend, based on the weight of the blend.

### BRIEF DESCRIPTION OF THE DRAWINGS

FIG. 1 is plot of the density of the foams prepared in the experiments in kilograms per cubic meter.

FIG. 2 is plot of the foam tensile strength in the machine direction (MD) in kilopascals (kPa) for the foams prepared in the experiments.

FIG. 3 is plot of the foam tensile strength in the transverse direction (TD) in kilopascals (kPa) for the foams prepared in the experiments.

FIG. 4 is a plot of the elongation in % of the machine direction (MD) for the foams prepared in the experiments.

FIG. 5 is a plot of the elongation in % in the transverse direction (TD) of the foams prepared in the experiments.

FIG. 6 is a plot of the tear resistance in kiloNewtons per meter (kN/m) in the machine direction (MD) of the foams prepared in the experiments.

FIG. 7 is a plot of the tear resistance in kiloNewtons per meter (kN/m) in the transverse direction (TD) of the foams prepared in the experiments.

FIG. 8 is a plot of the maximum load in Newtons of the puncture properties of the foams prepared in the experiments.

### DETAILED DESCRIPTION

In the present disclosure, Rosand Constant Haul off test refers to a test procedure under the following test conditions: Barrel Temperature: 230° C.; Die: 2-mm Diameter, L/D=20; Pressure Transducer: 10,000 psi (68.95 MPa); Piston Speed: 5.33 mm/min; Haul-off Angle: 52.degree; and Haul-off incremental speed: 500 m/(min).

As used in this patent specification, “MI” means melt index which is I₂ as determined by ASTM D-1238 condition (E) (i.e., grams of polymer extruded under a load of 2.16 kg. at 190° C. through a standard orifice in 10 minutes). Resin density was determined according to ASTM D792. Resin molecular weight data (Mn, Mw and Mw/Mn) was determined using ASTM D6474-12. Resin 2% secant flexural modulus (hereafter, flexural modulus or flex modulus) was determined using ASTM D790 (Procedure B, 0.051 in/min).

As used in this patent specification, “DSC” (ASTM D3418-08) refers to a process in which the relative flow of heat into a sample of polymer relative to a standard is determined as the sample and standard are heated at a standard rate (1° C. per minute) from a temperature at which is it solid to a temperature above its melting point (e.g., from 20° C. to 130° C. and the heat flow into the polymer is measured and plotted. From the heating and cooling plots, one can determine among other things maximum melting point and maximum crystallization temperature.

Foam physical properties were determined using the following procedures: foam density ASTM D3575 Suffix X; foam tensile strength (MD/TD) ASTM D3575 Suffix T; foam elongation (MD/TD) ASTM D3575 Suffix T, foam tear strength (MD/TD) ASTM D3575 Suffix G, and; foam puncture ASTM D3763 Standard Test Method for High Speed Puncture Properties of Plastics Using Load and Displacement Sensors.

The blends and foams of the present disclosure comprise a single site catalyzed polyethylene resin and a high pressure low density polyethylene resin.

High pressure low density polyethylene resins have been known since about the mid 1930's.

Polyethylene was originally produced industrially using a high pressure process. Although the process has been modified over time, it essentially comprises compressing ethylene to a high enough pressure so that it becomes a supercritical fluid. Typically, the pressures range from about 80 to about 310 MPa (e.g., about 11,500 psi to about 45,000 psi) preferably from about 200 to about 300 MPa (about 30,000 psi to about 43,500 psi) and the temperature ranges from about 130° C. to about 350° C., typically from about 150° C. to about 340° C. The supercritical ethylene together with one or more of initiators, chain transfer agent and optional comonomers are fed to a high pressure reactor. The reactor may be a tubular reactor. Tubular reactors may have a length from about 200 m to about 1500 m, and a diameter from about 20 mm to about 100 mm.

Thermocouples are located along the length of the reactor, typically, spaced at a distance from about 5 to about 15 meters, preferably about 8 to about 12 meters, most preferably from about 8 to about 11 meters. Generally, there may be from about 100 and about 350 thermocouples, typically, from about 120 to about 300 thermocouples spaced along the length of the reactor. The spacing of the thermocouples may not always be uniform along the length of the reactor.

Generally, there are a number of injection points spaced along the tubular reactor where additional components such as initiators, chain transfer agents, and monomers (preferably, cold monomers), may be added to the reactor. The design and operation of tubular reactors is illustrated by a number of patents including, for example, U.S. Pat. No. 3,334,081, issued Aug. 1, 1967 to Madgwick et al, assigned to Union Carbide Corporation; U.S. Pat. No. 3,399,185, issued Aug. 27, 1968 to Schappert assigned to Koppers Company, Inc., U.S. Pat. No. 3,917,577, issued Nov. 4, 1975 to Trieschmann et al., assigned to Badische Anilin & Soda-Fabrik Aktiengesellschaft; and U.S. Pat. No. 4,135,044, issued Jan. 16, 1979 to Beals assigned to Exxon Research & Engineering Co.

Generally, the initiator, or mixture of initiators, is injected into the reactor in amounts from about 100 to about 500 ppm, preferably from about 125 to about 425 ppm, (based on the weight of the reactants). The initiator(s) may be selected from the group consisting of oxygen, peroxides, persulphates, perborates, percarbonates, nitriles, and sulphides (methyl vinyl sulphide). Some free radical initiators can be selected from the list given in Ehrlich, P., et al., Fundamentals of the Free-Radical Polymerization of Ethylene, Advances in Polymer Science, Vol. 7, pp. 386-448, (1970).

Non-limiting examples of some free radical producing substances include oxygen (air); peroxide compounds such as hydrogen peroxide, decanoyl peroxide, t-butyl peroxy neodecanoate, t-butyl peroxypivalate, 3,5,5-trimethyl hexanoyl peroxide, diethyl peroxide, t-butyl peroxy-2-ethyl hexanoate, t-butyl peroxy isobutyrate, benzoyl peroxide, t-butyl peroxy acetate, t-butyl peroxy benzoate, di-t-butyl peroxide, and 1,1,3,3-tetramethyl butyl hydroperoxide; alkali metal persulfates, perborates and percarbonates; and azo compounds such as azo bis isobutyronitrite. Typically, initiators are selected from the group consisting of oxygen (air) and organic peroxides.

Generally, a chain transfer agent (sometimes referred to as a telogen or a modifier) is also present in the reactants. The chain transfer agent may be added at one or more points along the tubular reactor. Some chain transfer agents include the saturated aliphatic aldehydes, such as formaldehyde, acetaldehyde and the like; the saturated aliphatic ketones, such as acetone, diethyl ketone, diamyl ketone, and the like; the saturated aliphatic alcohols, such as methanol, ethanol, propanol, and the like; paraffins or cycloparafins such as pentane, hexane, cyclohexane, and the like; aromatic compounds such as toluene, diethylbenzene, xylene, and the like; and other compounds which act as chain terminating agents such as carbon tetrachloride, chloroform, etc.

The chain transfer agent may be used in amounts from about 0.20 to about 2 mole percent, preferably from about 0.24 to about 1 mole percent based on the total ethylene feed to the reactor.

In the foams and blends of the present disclosure, the feed for the high pressure low density resin is entirely ethylene. That is the polymer is a homopolymer.

Typically, the homopolymer will have a density from about 0.910 to about 0.925 g/cc, preferably from about 0.915 g/cc to about 0.920 g/cc, desirably from about 0.917 g/cc to about 0.919 g/cc; a melt index (at 2.16 kg/190° C.) from about 0.60 to about 6.0 g/10 min, preferably from about 0.70 to about 4.5 g/10 min.; a maximum melting temperature (DSC) from about 105° C. to about 112° C., in some embodiments from about 108° C. to about 110° C.; a maximum crystallization temperature from about 95° C. to about 100° C., in some embodiments from about 95° C. to about 98.5° C.; a melt strength from about 1.5 to about 10 cN, in some embodiments from about 2.0 to about 7.0 cN as determined by the Rosland Constant Haul Off method. Typically, the homopolymer has a flex modulus (ASTM D790) between about 206 MPa (30,000 psi) and about 552 KPa (80,000 psi) in some embodiments between about 241 MPa (35,000 psi) and about 445 MPa (65,000 psi).

The other component in the blends of the present disclosure is a single site catalyzed polyethylene copolymer. The active metal catalyst is typically a group IV or V transition metal, preferably selected from the group consisting of Ti, Zr, and Hf.

The single site catalyst may have a formula selected from the group consisting of:

(L)ₙ-M-(Y)ₚ

wherein M is selected from the group consisting of Ti, Zr, and Hf; L is a monoanionic ligand independently selected from the group consisting of cyclopentadienyl-type ligands, and a bulky heteroatom ligand containing not less than five atoms in total of which at least 20%, numerically are carbon atoms and further containing at least one heteroatom selected from the group consisting of boron, nitrogen, oxygen, phosphorus, sulfur and silicon, said bulky heteroatom ligand being sigma or pi-bonded to M; Y is independently selected for the group consisting of activatable ligands; n may be from 1 to 3; and p may be from 1 to 3, provided that the sum of n+p equals the valence state of M, and further provided that two L ligands may be bridged.

In one embodiment, the single site catalyst may be a metallocene type catalyst wherein L is a cyclopentadienyl type ligand and n, may be from 1 to 3, preferably 2.

The cyclopentadienyl-type ligand is a C₅₋₁₃ ligand containing a 5-membered carbon ring having delocalized bonding within the ring is bound to the metal atom (i.e., the active catalyst metal or site) through η⁵ bonds and said ligand being unsubstituted or up to fully substituted with one or more substituents selected from the group consisting of C₁₋₁₀ hydrocarbyl radicals in which hydrocarbyl substituents are unsubstituted or further substituted by one or more substituents selected from the group consisting of a halogen atom, preferably fluorine, a C₁₋₈ alkyl radical; a C₁₋₈ alkoxy radical; a C₆₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —Si—(R)₃ wherein each R is independently selected from the group consisting of hydrogen, a C₁₋₈ alkyl or alkoxy radical, and C₆₋₁₀ aryl or aryloxy radicals; and germanyl radicals of the formula —Ge—(R)₃ wherein R is as defined above. Preferably, the cyclopentadienyl ligand (Cp) is independently selected from the group consisting of a cyclopentadienyl radical, an indenyl radical and a fluorenyl radical.

In the single site type catalyst, two cyclopentadienyl ligands may be bridged or joined or one cyclopentadienly ligand may be bridged to a hetero atom ligand. If two cyclopentadienyl ligands are bridged or joined together or a cyclopentadienyl ligand is bridged to a hetero atom ligand, the catalyst may be a constrained geometry catalyst. Non-limiting examples of bridging groups include bridging groups containing at least one Group 13 to 16 atom, often referred to a divalent moiety, such as, but not limited to, at least one of a carbon, oxygen, nitrogen, silicon, boron, germanium and tin atom or a combination thereof. Preferably, the bridging group contains a carbon, silicon or germanium atom, most preferably at least one silicon atom or at least one carbon atom. The bridging group may also contain substituent radicals as defined above including halogens.

Some bridging groups include but are not limited to, a di C₁₋₆ alkyl radical (e.g., an ethyl bridge), di C₆₋₁₀ aryl radical (e.g., a benzyl radical having two bonding positions available), silicon or germanium radicals substituted by one or more radicals selected from the group consisting of C₁₋₆ alkyl, C₆₋₁₀ aryl, phosphine or amine radical which are unsubstituted or up to fully substituted by one or more C₁₋₆ alkyl or C₆₋₁₀ aryl radicals, or a hydrocarbyl radical, such as, a C₁₋₆ alkyl radical or a C₆₋₁₀ arylene (e.g., divalent aryl radicals); divalent C₁₋₆alkoxide radicals (e.g., —CH₂CHOHCH₂—) and the like.

Exemplary of the silyl species of bridging groups are dimethylsilyl, methylphenylsilyl, diethylsilyl, ethylphenylsilyl, diphenylsilyl bridged compounds. In some embodiments, the bridging species are selected from dimethylsilyl, diethylsilyl and methylphenylsilyl bridged compounds.

Exemplary hydrocarbyl radicals for bridging groups include methylene, ethylene, propylene, butylene, phenylene and the like. In some embodiments, the bridging group is methylene.

Exemplary bridging amides include dimethylamide, diethylamide, methylethylamide, di-t-butylamide, diisopropylamide and the like.

The activatable ligands (Y) may be independently selected from the group consisting of a hydrogen atom; a halogen atom, a C₁₋₁₀ hydrocarbyl radical; a C₁₋₁₀ alkoxy radical; a C₅₋₁₀ aryl oxide radical; each of which said hydrocarbyl, alkoxy, and aryl oxide radicals may be unsubstituted by or further substituted by one or more substituents selected from the group consisting of a halogen atom; a C₁₋₈ alkyl radical; a C₁₋₈ alkoxy radical; a C₆₋₁₀ aryl or aryloxy radical; an amido radical which is unsubstituted or substituted by up to two C₁₋₈ alkyl radicals; and a phosphido radical which is unsubstituted or substituted by up to two C₁₋₈ alkyl radicals. In some embodiments, Y is independently selected from the group consisting of a hydrogen atom, a chlorine atom and a C₁₋₄ alkyl radical.

In one embodiment of this disclosure, the catalyst may contain a bulky heteroatom ligand. The bulky heteroatom ligand is selected from the group consisting of phosphinimine ligands, ketimide ligands, silicon-containing heteroatom ligands, amido ligands, alkoxy ligands, boron heterocyclic ligands and phosphole ligands.

If the catalyst contains one or more bulky heteroatom ligands, the catalyst would have the formula:

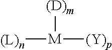

wherein M is a transition metal selected from the group consisting of Ti, Hf and Zr; D is independently a bulky heteroatom ligand (as described below); L is a monoanionic ligand of cyclopentadienyl-type ligands; Y is independently selected from the group consisting of activatable ligands; m is 1 or 2; n is 0 or 1; and p is an integer and the sum of m+n+p equals the valence state of M, provided that when m is 2, D may be the same or different bulky heteroatom ligands.

Bulky heteroatom ligands (D) include but are not limited to phosphinimine ligands and ketimide (ketimine) ligands.

In a further embodiment, the catalyst may contain one or two phosphinimine ligands (PI) which are bonded to the metal with the formula:

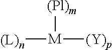

wherein M is a group 4 metal; PI is a phosphinimine ligand; L is a monoanionic ligand of the cyclopentadienyl-type ligand; Y is independently selected from the group consisting of activatable ligands; m is 1 or 2; n is 0 or 1; p is an integer and the sum of m+n+p equals the valence state of M.

The phosphinimine ligand is defined by the formula:

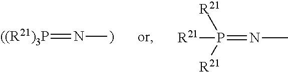

wherein each R²¹ is independently selected from a hydrogen atom; a halogen atom; C₁₋₂₀, preferably C₁₋₁₀ hydrocarbyl radicals which are unsubstituted by or further substituted by a halogen atom; a C₁₋₈ alkoxy radical; a C₆₋₁₀ aryl or aryloxy radical; an amido radical; a silyl radical of the formula:

—Si—(R²²)₃

wherein each R²² is independently selected from the group consisting of hydrogen, a C₁₋₈ alkyl or alkoxy radical, and C₆₋₁₀ aryl or aryloxy radicals; and a germanyl radical of the formula:

—Ge—(R²²)₃

wherein R²² is as defined above.

The preferred phosphinimines are those in which each R²¹ is a hydrocarbyl radical, preferably a C₁₋₆ hydrocarbyl radical.

Suitable phosphinimine catalysts are Group 4 organometallic complexes which contain one phosphinimine ligand (as described above) and one ligand L which is either a cyclopentadienyl-type ligand or a heteroatom ligand.

As used herein, the term “ketimide ligand” refers to a ligand which:

is bonded to the transition metal via a metal-nitrogen atom bond;

has a single substituent on the nitrogen atom (where this single substituent is a carbon atom which is doubly bonded to the N atom); and

has two substituents Sub 1 and Sub 2 (described below) which are bonded to the carbon atom.

Conditions a, b and c are illustrated below:

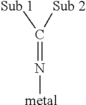

The substituents “Sub 1” and “Sub 2” may be the same or different. Exemplary substituents include hydrocarbyl radicals having from 1 to 20, preferably from 3 to 6, carbon atoms, silyl groups (as described below), amido groups (as described below) and phosphido groups (as described below). For reasons of cost and convenience, it is preferred that these substituents both be hydrocarbyls, especially, simple alkyls and most preferably tertiary butyl. “Sub 1” and “Sub 2” may be the same or different and can be bonded to each other to form a ring.

Suitable ketimide catalysts are Group 4 organometallic complexes which contain one ketimide ligand (as described above) and one ligand L which is either a cyclopentadienyl-type ligand or a heteroatom ligand.

The term bulky heteroatom ligand (D) is not limited to phosphinimine or ketimide ligands and includes ligands which contain at least one heteroatom selected from the group consisting of boron, nitrogen, oxygen, phosphorus, sulfur and silicon. The heteroatom ligand may be sigma or pi-bonded to the metal. Exemplary heteroatom ligands include silicon-containing heteroatom ligands, amido ligands, alkoxy ligands, boron heterocyclic ligands and phosphole ligands, as all described below.

Silicon containing heteroatom ligands are defined by the formula:

(Y)SiRₓR_{y}R_{z}

wherein the - denotes a bond to the transition metal and Y is sulfur or oxygen.

The substituents on the Si atom, namely Rₓ, R_{y} and R_{z} are required in order to satisfy the bonding orbital of the Si atom. The use of any particular substituent Rₓ, R_{y} or R_{z} is not especially important to the success of this disclosure. It is preferred that each of Rₓ, R_{y} and R_{z} is a C₁₋₂ hydrocarbyl group (i.e., methyl or ethyl) simply because such materials are readily synthesized from commercially available materials.

The term “amido” is meant to convey its broad, conventional meaning. Thus, these ligands are characterized by (a) a metal-nitrogen bond; and (b) the presence of two substituents (which are typically simple alkyl or silyl groups) on the nitrogen atom.

The terms “alkoxy” and “aryloxy” is also intended to convey its conventional meaning. Thus, these ligands are characterized by (a) a metal oxygen bond; and (b) the presence of a hydrocarbyl group bonded to the oxygen atom. The hydrocarbyl group may be a C₁₋₁₀ straight chained, branched or cyclic alkyl radical or a C₆₋₁₃ aromatic radical where the radicals are unsubstituted or further substituted by one or more C₁₋₄ alkyl radicals (e.g., 2,6-di-tertiary butyl phenoxy).

Boron heterocyclic ligands are characterized by the presence of a boron atom in a closed ring ligand. This definition includes heterocyclic ligands which also contain a nitrogen atom in the ring. These ligands are well known to those skilled in the art of olefin polymerization and are fully described in the literature (see, for example, U.S. Pat. Nos. 5,637,659; 5,554,775; and the references cited therein).

The term “phosphole” is also meant to convey its conventional meaning. “Phospholes” are cyclic dienyl structures having four carbon atoms and one phosphorus atom in the closed ring. The simplest phosphole is C₄PH₄ (which is analogous to cyclopentadiene with one carbon in the ring being replaced by phosphorus). The phosphole ligands may be substituted with, for example, C₁₋₂₀ hydrocarbyl radicals (which may, optionally, contain halogen substituents); phosphido radicals; amido radicals; or silyl or alkoxy radicals. Phosphole ligands are also well known to those skilled in the art of olefin polymerization and are described as such in U.S. Pat. No. 5,434,116 (Sone, to Tosoh).

In one embodiment, the catalyst may contain no phosphinimine ligands as the bulky heteroatom ligand. The bulky heteroatom containing ligand may be selected from the group consisting of ketimide ligands, silicon-containing heteroatom ligands, amido ligands, alkoxy ligands, boron heterocyclic ligands and phosphole ligands. In such catalysts, the Cp ligand may be present or absent.

Useful metals (M) are from Group 4 including titanium, hafnium or zirconium.

For gas phase or slurry phase polymerization the catalyst may be supported.

The catalyst system of the present disclosure may be supported on an inorganic or refractory support, including, for example, alumina, silica and clays or modified clays or an organic support (including polymeric support, such as, polystyrene or cross-linked polystyrene). The catalyst support may be a combination of the above components. However, preferably the catalyst is supported on an inorganic support or an organic support (e.g., polymeric) or mixed support. Some refractories include silica, which may be treated to reduce surface hydroxyl groups and alumina. The support or carrier may be a spray-dried silica. Generally, the support will have an average particle size from about 0.1 to about 1,000, in some embodiments, from about 10 to about 150 microns. The support typically will have a surface area of at least about 10 m²/g, in some embodiments from about 150 to about 1,500 m²/g. The pore volume of the support should be at least 0.2 ml/g, in some embodiments from about 0.3 to about 5.0 ml/g.

Generally the refractory or inorganic support may be heated at a temperature of at least 200° C. for up to 24 hours, typically, at a temperature from about 500° C. to about 800° C. for about 2 to about 20 hours, in some embodiments, from about 4 to about 10 hours. The resulting support will be essentially free of adsorbed water (e.g., less than about 1 weight %) and may have a surface hydroxyl content from about 0.1 to about 5 mmol/g of support, in some embodiments, from about 0.5 to about 3 mmol/g.

A silica suitable for use in the present disclosure has a high surface area and is amorphous. For example, commercially available silicas are marketed under the trademark of Sylopol® 958 and 955 by Davison Catalysts, a Division of W.R. Grace, and Company and ES-70W sold by Ineos Silica.

The amount of the hydroxyl groups in silica may be determined according to the method disclosed by J. B. Peri and A. L. Hensley, Jr., in J. Phys. Chem., 72 (8), 2926, 1968, the entire contents of which are incorporated herein by reference.

While heating is the most preferred means of removing OH groups inherently present in many carriers, such as silica, the OH groups may also be removed by other removal means, such as chemical means. For example, a desired proportion of OH groups may be reacted with a suitable chemical agent, such as a hydroxyl reactive aluminum compound (e.g., triethyl aluminum) or a silane compound. This method of treatment has been disclosed in the literature and two relevant examples are: U.S. Pat. No. 4,719,193 to Levine in 1988 and by Noshay A. and Karol F. J. in Transition Metal Catalyzed Polymerizations, Ed. R. Quirk, 396, 1989. For example, the support may be treated with an aluminum compound of the formula Al((O)ₐR¹)_{b}X_{3-b} wherein a is either 0 or 1, b is an integer from 0 to 3, R¹ is a C₁₋₈alkyl radical, and X is a chlorine atom. The amount of aluminum compound is such that the amount of aluminum on the support prior to adding the remaining catalyst components will be from about 0 to about 2.5 weight %, in some embodiments, from 0 to about 2.0 weight % based on the weight of the support.

The clay type supports are also preferably treated to reduce adsorbed water and surface hydroxyl groups. However, the clays may be further subject to an ion exchange process, which may tend to increase the separation or distance between the adjacent layers of the clay structure.

The polymeric support may be cross linked polystyrene containing up to about 50 weight %, in some embodiments, not more than about 25 weight %, in further embodiments, less than about 10 weight % of a cross linking agent, such as, divinyl benzene.

The single site catalysts in accordance with the present disclosure may be activated with:

i) an activator selected from the group consisting of:

a complex aluminum compound of the formula R¹²₂AlO(R¹²AlO)ₘAlR¹²₂, wherein each R¹² is independently selected from the group consisting of C₁₋₂₀ hydrocarbyl radicals and m is from 3 to 50, and, optionally, a hindered phenol to provide a molar ratio of Al:hindered phenol from 2:1 to 5:1, if the hindered phenol is present;

(ii) ionic activators selected from the group consisting of:

compounds of the formula [R¹³]⁺[B(R¹⁴)₄]⁻ wherein B is a boron atom, R¹³ is a cyclic C₅₋₇ aromatic cation or a triphenyl methyl cation and each R¹⁴ is independently selected from the group consisting of phenyl radicals which are unsubstituted or substituted with a hydroxyl group or with 3 to 5 substituents selected from the group consisting of a fluorine atom, a C₁₋₄ alkyl or alkoxy radical which is unsubstituted or substituted by a fluorine atom and a silyl radical of the formula —Si—(R¹⁵)₃, wherein each R¹⁵ is independently selected from the group consisting of a hydrogen atom and a C₁₋₄ alkyl radical; and

compounds of the formula [(R¹⁸)ₜZH]+[B(R¹⁴)₄] wherein B is a boron atom, H is a hydrogen atom, Z is a nitrogen atom or phosphorus atom, t is 2 or 3 and R¹⁸ is independently selected from the group consisting of C₁₋₁₈ alkyl radicals, a phenyl radical which is unsubstituted or substituted by up to three C₁₋₄ alkyl radicals, or one R¹⁸ taken together with the nitrogen atom may form an anilinium radical and R¹⁴ is as defined above; and

compounds of the formula B(R¹⁴)₃, wherein R¹⁴ is as defined above; and

(iii) mixtures of (i) and (ii).

In some embodiments, the activator is a complex aluminum compound of the formula R¹²₂AlO(R¹²AlO)ₘAlR¹²₂ wherein each R¹² is independently selected from the group consisting of C₁₋₂₀ hydrocarbyl radicals and m is from 3 to 50, and optionally a hindered phenol to provide a molar ratio of Al:hindered phenol from about 2:1 to about 5:1 if the hindered phenol is present. In some embodiments, in the aluminum compound R¹² is methyl radical and m is from 10 to 40. In some embodiments, the molar ratio of Al:hindered phenol, if it is present, is from about 3.25:1 to about 4.50:1. In some embodiments, the phenol is substituted in the 2, 4 and 6 position by a C₂₋₆ alkyl radical. Desirably, the hindered phenol is 2,6-di-tert-butyl-4-ethyl-phenol.

The aluminum compounds (alumoxanes and, optionally, hindered phenol) are typically used as activators in substantial molar excess compared to the amount of metal in the catalyst. Aluminum:transition metal molar ratios may be from about 10:1 to about 10,000:1, in some instances, from about 10:1 to about 500:1; in other embodiments, from about 40:1 to about 120:1.

Ionic activators are well known to those skilled in the art. The “ionic activator” may abstract one activatable ligand so as to ionize the catalyst center into a cation, but not to covalently bond with the catalyst and to provide sufficient distance between the catalyst and the ionizing activator to permit a polymerizable olefin to enter the resulting active site.

Examples of ionic activators include:
triethylammonium tetra(phenyl)boron,
tripropylammonium tetra(phenyl)boron,
tri(n-butyl)ammonium tetra(phenyl)boron,
trimethylammonium tetra(p-tolyl)boron,
trimethylammonium tetra(o-tolyl)boron,
tributylammonium tetra(pentafluorophenyl)boron,
tripropylammonium tetra(o,p-dimethylphenyl)boron,
tributylammonium tetra(m,m-dimethylphenyl)boron,
tributylammonium tetra(p-trifluoromethylphenyl)boron,
tributylammonium tetra(pentafluorophenyl)boron,
tri(n-butyl)ammonium tetra(o-tolyl)boron,
N,N-dimethylanilinium tetra(phenyl)boron,
N,N-diethylanilinium tetra(phenyl)boron,
N, N-diethylanilinium tetra(phenyl)n-butylboron,
di-(isopropyl)ammonium tetra(pentafluorophenyl)boron,
dicyclohexylammonium tetra(phenyl)boron,
triphenylphosphonium tetra(phenyl)boron,
tri(methylphenyl)phosphonium tetra(phenyl)boron,
tri(dimethylphenyl)phosphonium tetra(phenyl)boron,
tropillium tetrakispentafluorophenyl borate,
triphenylmethylium tetrakispentafluorophenyl borate,
tropillium phenyltrispentafluorophenyl borate,
triphenylmethylium phenyltrispentafluorophenyl borate,
benzene (diazonium) phenyltrispentafluorophenyl borate,
tropillium tetrakis (2,3,5,6-tetrafluorophenyl) borate,
triphenylmethylium tetrakis (2,3,5,6-tetrafluorophenyl) borate,
tropillium tetrakis (3,4,5-trifluorophenyl) borate,
benzene (diazonium) tetrakis (3,4,5-trifluorophenyl) borate,
tropillium tetrakis (1,2,2-trifluoroethenyl) borate,
triphenylmethylium tetrakis (1,2,2-trifluoroethenyl) borate,
tropillium tetrakis (2,3,4,5-tetrafluorophenyl) borate, and
triphenylmethylium tetrakis (2,3,4,5-tetrafluorophenyl) borate.
Readily commercially available ionic activators include:
N,N-dimethylaniliniumtetrakispentafluorophenyl borate;
triphenylmethylium tetrakispentafluorophenyl borate (tritylborate); and
trispentafluorophenyl borane.

Ionic activators may also have an anion containing at least one group comprising an active hydrogen or at least one of any substituent able to react with the support. As a result of these reactive substituents, the ionic portion of these ionic activators may become bonded to the support under suitable conditions. One non-limiting example includes ionic activators with tris (pentafluorophenyl) (4-hydroxyphenyl) borate as the anion. These tethered ionic activators are more fully described in U.S. Pat. Nos. 5,834,393, 5,783,512 and 6,087,293.

In accordance with the present disclosure, the polyethylene may be prepared by solution, slurry or gas phase processes.

Solution and slurry polymerization processes are fairly well known in the art. These processes are conducted tubular (e.g., loop reactors), and tank reactors (continuously stirred tank reactors) in the presence of an inert hydrocarbon solvent, typically, a C₄₋₁₂ hydrocarbon which may be unsubstituted or substituted by a C₁₋₄ alkyl group, such as, butane, pentane, hexane, heptane, octane, cyclohexane, methylcyclohexane or hydrogenated naphtha. An additional, solvent is Isopar E (C₈₋₁₂ aliphatic solvent, commercially available from Exxon Chemical Co.).

The polymerization may be conducted at temperatures from about 20° C. to about 250° C. Depending on the product being made, this temperature may be relatively low, such as, from about 20° C. to about 180° C., typically, from about 80° C. to about 150° C. and the polymer is insoluble in the liquid hydrocarbon phase (diluent) (e.g., a slurry polymerization). The reaction temperature may be relatively higher from about 180° C. to about 250° C., preferably, from about 180° C. to about 230° C. and the polymer is soluble in the liquid hydrocarbon phase (solvent). The pressure of the reaction may be as high as about 15,000 psig for the older high pressure processes or may range from about 15 to about 4,500 psig.

In gas phase polymerization, a gaseous mixture comprising from 0 to about 15 mole % of hydrogen, monomers as noted above, and from 0 to about 75 mole % of an inert gas at a temperature from about 50° C. to about 120° C., preferably, from about 75° C. to about 110° C., and at pressures, typically, not exceeding about 3447 kPa (about 500 psi), preferably not greater than about 2414 kPa (about 350 psi) is contacted with a supported catalyst in a fluidized bed in a reactor, typically, comprising a vertical tubular reactor having a gas inlet at the bottom, a disperser or bed plate above the inlet upon which the bed is supported, a catalyst injector above the bed plate, a letdown system to withdraw polymer granules from the bed, a disengagement zone above the tubular reactor and a recycle system comprising piping and an inlet for make-up monomer(s), a compressor and a heat exchanger to recycle gas from the top of the disengagement zone to the inlet for the reactor. The velocity of the gas passing through the bed is sufficient to fluidized the bed.

In addition to monomers and ballast gas (e.g., nitrogen) the gas phase process, typically, comprises a condensable lower (C₄₋₆) alkane which condenses as it passes through the heat exchanger. The condensed phase evaporates in the bed to remove heat from the reaction. The gas phase may contain from about 10 to about 50 wt % of condensable phase, typically, from about 18 to about 35 wt %, preferably, from about 20 to about 30 wt % of condensable gas.

Typically, the single sited catalyzed polymer will comprise from about 80 to about 95 weight %, in some embodiments, from about 85 to about 95 weight % of ethylene and from about 20 to about 5 weight %, in some embodiments, about 15 to about 5 weight % of one or more C₄₋₈ alpha olefins; non-limiting examples of alpha olefins include hexene and octene. The polymer resulting from the polymerization, in the presence of the single site catalyst (singles site polymer), should have the following properties: a density from about 0.915 to about 0.918 g/cc; a melt index from about 0.60 to about 1.2 g/10 min (at 2.16 kg/190° C.); a maximum melting temperature (DSC) from about 108° C. to about 112° C.; a maximum crystallization temperature (DSC) within 6° C. of that of component i) (e.g., about 98° C. to about 102° C., and in other embodiments about 99° C. to about 100° C.); a flextural modulus between about 206 MPa (30,000 psi) and about 620 MPa (90,000 psi), in other embodiments, a flex modulus between about 241 MPa (35,000 psi) and about 448 MPa (65,000 psi), in other embodiments, the flex modulus may be between about 241 MPa (35,000 psi) and about 379 MPa (55,000 psi) and a melt strength from about 1 to about 2 cN as determined by the Rosand Constant Haul Off method;

The components for the blends described in this disclosure are selected so that the difference in maximum melting temperature for components i) and ii) is 4° C. or less, in some embodiments, less than 2° C.; and the difference between the maximum crystallization temperature of the component is less than 4° C., in some embodiments, less than 2° C.

The blends of the present disclosure may be prepared in any convenient manner. Typically, the components are dry blended in an amount to provide from about 60 to about 90 weight %, in some embodiments, from about 80 to about 60 weight % of the homopolymer (i.e., component (i)) and, correspondingly, from about 40 to about 10 weight %, in some embodiments, from about 40 to about 20 weight % of the single site polymer (i.e., component (ii)). The blends are, typically, dry blended, e.g., tumble blended before being extruded or melt blended in the extruder. The components could be solution blended but that is an expensive process as the removal of solvent is required. The blend may have a flexural modulus between about 206 MPa (30,000 psi) and about 620 MPa (90,000 psi), in some embodiments, a flexural modulus between about 241 MPa (35,000 psi) and about 448 MPa (65,000 psi), in other embodiments, the flexural modulus may be between about 241 MPa (35,000 psi) and about 379 MPa (55,000 psi).

The blend is passed through an extruder and blown to form a foam. Typically, the blowing agent is added from about 5 to about 25 weight %, in some embodiments, from about 8 to about 20 weight %, in other embodiments, from about 10 to about 18 weight % based on the total weight of the polymer blend. Some blowing agents include the following types of compounds: lower (C₄₋₆) aliphatic hydrocarbons which are unsubstituted or substituted by one or more atoms selected from the group consisting of a chlorine atom and a fluorine atom (typically, injected into the polymer melt in the extruder); aliphatic hydrocarbons, including methane, ethane, propane, n-butane, isobutane, n-pentane, isopentane, neopentane, and the like; aliphatic alcohols including methanol, ethanol, n-propanol, and isopropanol, and; fully and partially halogenated aliphatic hydrocarbons including fluorocarbons, chlorocarbons, and chlorofluorocarbons. Non-limiting, examples of fluorocarbons include methyl fluoride, perfluoromethane, ethyl fluoride, 1,1-difluoroethane (HFC-152a), 1,1,1-trifluoroethane (HFC-143a), 1,1,1,2-tetrafluoro-ethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane. Non-limiting examples of partially halogenated chlorocarbons and chlorofluorocarbons for use in this disclosure include methyl chloride, methylene chloride, ethyl chloride, 1,1,1-trichloroethane, 1,1-dichloro-1-fluoroethane (HCFC-141b), 1-chloro-1,1-difluoroethane (HCFC-142b), chlorodifluoromethane (HCFC-22), 1,1-dichloro-2,2,2-trifluoroethane (HCFC-123) and 1-chloro-1,2,2,2-tetrafluoroethane (HCFC-124). Non-limiting examples of fully halogenated chlorofluorocarbons include trichloromonofluoromethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane.

A less used approach is to incorporate an inorganic compound into the blend prior to extrusion which decomposes in the extruder to produce a gas; typically, carbon dioxide, such as, a metal carboxylate, typically, a group 1 or 2 metal carbonate, such as, calcium carbonate. A solid organic compound may also be added to the blend to produce nitrogen when the compound decomposes under the extrusion conditions, such as, azodicarbonamide (1,1′-azobisformamide). Some inorganic blowing agents include azodicarbonamide, azodiisobutyro-nitrile, benzenesulfon-hydrazide, 4,4-oxybenzene sulfonylsemicarbazide, p-toluene sulfonyl semi-carbazide, barium azodicarboxylate, N,N′-dimethyl-N,N′-dinitrosoterephthalamide, N,N′-dinitrosopentamethylenetetramine, 4-4-oxybis (benzenesulfonylhydrazide), and trihydrazino triazine.

The polyethylene components or the blend will, typically, contain the usual additives including heat and light stabilizers and UV stabilizers and any pigments required.

The process of foaming the blends of the present disclosure is well known. The blend is fed to an extruder, either single or twin screw. The extruder will have a number of different temperature zones, typically, from three to five or more. The screws may have kneading elements in some sections. The blend is melted by a combination of temperature control in the barrel and friction and kneading in the barrel. The blend is heated to above its melting point (e.g., from about 80 to about 130° C., in some instances, from about 95 to about 115° C.) and the blowing agent may be injected into the blend or if a solid blowing agent is used mixed with the blend and the blend is heated to the decomposition temperature of the blowing agent. The extruder has a number of zones (from 1 to about 6) and a heated die. The temperatures through the extruder and die may fall within the range from about 90° C. to about 140° C. In the extruder, the molten polymer blend is under pressure and does not foam. The blend exits the extruder through a die and is exposed to atmospheric pressure and the melt foams. Upon cooling, the foam is stabilized, forming a solid foamed mass. Depending on the processing conditions, the foam may be closed cell, open cell or a mixture of closed and open cell foam. In some embodiments, the foam may comprise from about 20 to about 30% of closed cells. The foam may then be further processed by cutting into required size and shape.

The resulting foam blend has melt strength from about 3.50 to about 12 cN, in some embodiments, from about 2.5 to about 8.0 cN, as determined by the Rosand Constant Haul Off method; a difference of less than 6° C., in some embodiments, a difference of less than 4° C., in other embodiments, and a difference of less than 2° C., in still other embodiments, between the maximum melting temperatures of the components; a difference of less than 4° C., in some embodiments, and a difference of less than 2° C., in other embodiments, between the maximum crystallization temperature of the components, and; a melt index of less than about 10 g/10 minutes. The foam may have a density from about 10 kg/m³ (about 0.6 pounds per cubic foot (pcf)) to about 20 kg/m³ (about 1.25 pcf), in some embodiments, from about 13 kg/M³ (about 0.8 pcf) to about 19 kg/m³ (about 1.20 pcf).

The profile of the foam is partially determined by the shape of the die. The foam may be oval or circular in cross section but generally is square or rectangular in cross section. In some embodiments, the slab, or plank, of foam may be split (e.g., formed as a half inch thick foam and then split into two slabs % inch thick) or may be cut into smaller widths.

The present disclosure will now be illustrated by the following experiments.

In the experiments, the melt strength, measured in centi-Newtons (cN), was determine by the Rosand Constant Haul Off (CHO) Method as described in U.S. Pat. No. 6,185,349, from col. 4, line 53 through col. 5, line 5, wherein using 10 incremental haul-off speed starting at 1 mm/min each stage increasing by 1 mm/min; the haul off speed is increased by 1 mm/minute at each stage; a piston speed is 5 mm per minute under a force of 0.54 kN. The “melt strength” (CHO) is defined as the force at the speed where the extrudate breaks.

“MI” (I₂) was determined by ASTM D-1238 condition (E) (i.e., grams of polymer extruded under a load of 2.16 kg. at 190° C. through a standard orifice in g/10 minutes.)

“DSC” refers to a process in which the relative flow of heat into a sample of polymer relative to a standard is determined as the sample and standard are heated at a standard rate (1° C. per minute) from a temperature at which is it solid to a temperature above its melting point (e.g., from 20° C. to 130° C. and the heat flow into the polymer is measured and plotted. From this plot, one can determine among other things maximum melting point; maximum the crystallization temperature is determined from the cooling curve plot (1° C. per minute).

Stress exponent is determine by measuring the throughput of a melt indexer at two stresses (2160 g and 6480 g loading) using the procedures of ASTM D-1238, and applying the following formula:

Stress exponent=log(I₆/I₂)/log(6480/2160)

where I₆ is the weight of polymer extruded with a 6480 g load, and I₂ is the weight of polymer extruded with a 2160 g load.

In the experiments, the resins shown in Table 1 were used to prepare the blends of polyethylene polymers.

The low density resins (homopolymers) were NOVAPOL LA0219-A (219), NOVAPOL LA-0522-A (522) and NOVAPOL LF-Y819. The single site resins were SURPASS FPs 016.

TABLE 1
Properties of polyethylene homopolymers (LDPE) and a single
site catalyzed polyethylene copolymer (FPS016-C).

| Property | Units | LA-0522-A | LA-0219-A | LF-Y819-A | FPS016-C |
|---|---|---|---|---|---|
| Density | G/CM3 | 0.9196 | 0.9176 | 0.9192 | 0.9162 |
| Melt index, I2 | G/10 MIN | 4.32 | 2.19 | 0.69 | 0.6 |
| Melt index, I21 | G/10 MIN | 233 | 116 | 50 | 16.1 |
| MFR | G/10 MIN | 54 | 53 | 73 | 26.9 |
| SEX(stress | G/10 MIN | 1.62 | 1.66 | 1.75 | 1.26 |
| exponent) | | | | | |
| Melt Strength, | cN | 1.96 | 3.67 | 6.43 | 1.85 |
| CHO¹ | | | | | |
| MN BY | — | 17738 | 16698 | 18983 | 37269 |
| GPC-VISC | | | | | |
| MW BY | — | 139251 | 173141 | 198572 | 124467 |
| GPC-VISC | | | | | |
| MZ BY | — | 400200 | 521142 | 597205 | 280840 |
| GPC-VISC | | | | | |
| Polydispersity | — | 7.85 | 10.37 | 10.46 | 3.34 |
| (MW/MN) | | | | | |
| Maximum | ° C. | 109.2 | 108.4 | 109.6 | 110.9 |
| Melting | | | | | |
| Temperature | | | | | |
| Crystallization | ° C. | 98.3 | 95.3 | 97.9 | 99.5 |
| point | | | | | |
| Flexural | psi | 35679 | 34229 | 38464^{a} | 32924 |
| Modulus 2% | | | | | |
| Secant | | | | | |

¹Constant Haul Off (CHO) method
^{a}Calculated from density: (2% Flex. Mod [psi] = 2.420 × 10⁶ × Density − 2.186 × 10⁶)

Blends were made of the LDPE (homopolymer) with 10 wt. % of the resin produced with a single site catalyst.

Table 2 discloses examples of blend properties that illustrate selected embodiments of this disclosure, these examples do not limit the claims presented.

TABLE 2
Polyethylene polymer blend properties.

| | | 2701 | 2702 | 2703 |
|---|---|---|---|---|
| | | LA-0522-A + 10 | LA-0219-A + 10 | LF-Y819-A + 10 |
| Formulation | | wt % FPS016-C | wt % FPS016-C | wt % FPS016-C |
| Density | G/CM3 | 0.92 | 0.9182 | 0.9192 |
| Melt index, I2 | G/10 MIN | 2.66 | 1.54 | 0.66 |
| Melt index, I21 | G/10 MIN | 137 | 85.2 | 39.2 |
| MFR | G/10 MIN | 51.7 | 55.2 | 59.1 |
| SEX | G/10 MIN | 1.63 | 1.64 | 1.68 |
| Melt Strength, | cN | 2.63 | 4.58 | 7.65 |
| CHO | | | | |
| Mn BY | — | 18154 | 17545 | 19488 |
| GPC-VISC | | | | |
| Mw BY | — | 131723 | 170566 | 178439 |
| GPC-VISC | | | | |
| Mz BY | — | 366113 | 522489 | 513119 |
| GPC-VISC | | | | |
| Polydispersity | — | 7.26 | 9.72 | 9.16 |
| (MW/MN) | | | | |
| Flexural | psi | 38636^{b} | 34280^{b} | 37765^{b} |
| Modulus 2% | | | | |
| Secant | | | | |

¹Constant Haul Off (CHO) method
^{b}Calculated: (2% Flex. Mod [psi] = f^{LDPE} × Flex. Mod^{LDPE} + (1 − f^{LDPE}) × Flex. Mod^{LLDPE}); where f^{LDPE} is the weight fraction of LDPE and f^{LDPE} + f^{LLDPE} = 1

The blends were foamed using a Gemini GP twin screw extruder with an L/D ratio of 32. The extruder had a number of zones heated from 195° F. (90° C.) to 280° F. (193° C.). The die was designed to produce a 48 inch (122 cm) wide slab having a thickness of 1/32 (0.08 cm) of an inch or ¼ of an inch (0.6 cm).

The amount of blowing agent, isobutane, fed to the extruder was varied from 44 to 84 pounds per hour (pph). The initial goal was to reduce the density of the foam. Isobutene was added through an injection pump into the polymer melt contained inside the extruder barrel. Tables 3A and 3B summarizes these experiments and the physical properties of the foams produced. In Table 3A, the Control Orange, ⅛″ foam sample was produced from LA-0219-A using 84.8 pph of isobutene; the remaining foams in Table 3A contained 90 wt % LA-0219-A and 10 wt % FPS0160-C. In Table 3B, the Control Blue, 1/16″ foam sample was produced from LA-0219-A using 48.0 pph of isobutene, and; the Control Black, 1/32″ foam sample was produced from LF-Y819-A using 48.0 pph of isobutene.

TABLE 3A
Physical properties of foams.

| | Control | 2701-1 | 2702-1 | 2702-2 | 2702-3 |
|---|---|---|---|---|---|
| | Orange, | Orange, | Orange, | Orange, | Orange, |
| | ⅛″ | ⅛″ | ⅛″ | ⅛″ | ⅛″ |
| Isobutane, pph | 84.8 | 84.8 | 84.0 | 84.0 | 84.0 |
| Foam Density, | 19.06 | 16.91 | 16.26 | 15.21 | 14.08 |
| kg/m³ | | | | | |
| Tensile Strength, | 444.2 | 361.4 | 452.2 | 393.1 | 386.9 |
| kPa, MD | | | | | |
| Tensile Strength, | 165.6 | 170.4 | 175.8 | 163.0 | 155.6 |
| kPa, TD | | | | | |
| Elongation, | 75.55 | 108.2 | 97.21 | 92.48 | 85.29 |
| %, MD | | | | | |
| Elongation, | 66.00 | 127.8 | 104.0 | 91.40 | 83.90 |
| %, TD | | | | | |
| Tear | 1.657 | 1.735 | 1.709 | 1.547 | 1.516 |
| Resistance, | | | | | |
| kN/m, MD | | | | | |
| Tear | 0.9386 | 1.240 | 1.160 | 0.9448 | 0.9755 |
| Resistance, | | | | | |
| kN/m, CMD | | | | | |
| Maximum | 38.87 | 41.07 | 44.00 | 39.05 | 35.12 |
| Load, | | | | | |
| Newton | | | | | |

TABLE 3B
Physical properties of foams.

| | Control | 2703-1 | 2703-2 | 2703-3 | Control | 2703-4 |
|---|---|---|---|---|---|---|
| | Blue, | Blue, | Blue | Blue | Black, | Black |
| | 1/16″ | 1/16″ | 1/16″ | 1/16″ | 1/32″ | 1/32″ |
| Isobutane, | 48.0 | 48.0 | 48.0 | 53.0 | 48.0 | 44.0 |
| pph | | | | | | |
| Foam | 19.69 | 19.69 | 16.62 | 13.61 | 20.35 | 20.23 |
| Density, | | | | | | |
| kg/m³ | | | | | | |
| Tensile | 416.8 | 566.3 | 540.8 | 503.0 | 706.3 | 629.8 |
| Strength, | | | | | | |
| kPa, MD | | | | | | |
| Tensile | 177.8 | 213.7 | 193.1 | 171.1 | 249.7 | 230.2 |
| Strength, | | | | | | |
| psi, CMD | | | | | | |
| Elongation, | 82.06 | 70.48 | 62.00 | 54.28 | 48.87 | 53.11 |
| %, MD | | | | | | |
| Elongation, | 73.19 | 97.01 | 93.73 | 92.00 | 96.33 | 91.39 |
| %, CMD | | | | | | |
| Tear | 1.634 | 2.213 | 1.908 | 1.593 | 2.258 | 2.028 |
| Resistance, | | | | | | |
| kN/m, MD | | | | | | |
| Tear | 1.031 | 1.280 | 1.001 | 1.021 | 1.286 | 1.371 |
| Resistance, | | | | | | |
| kN/m, CMD | | | | | | |
| Maximum | 23.43 | 30.03 | 26.60 | 24.05 | 20.32 | 22.45 |
| Load, | | | | | | |
| Newton | | | | | | |

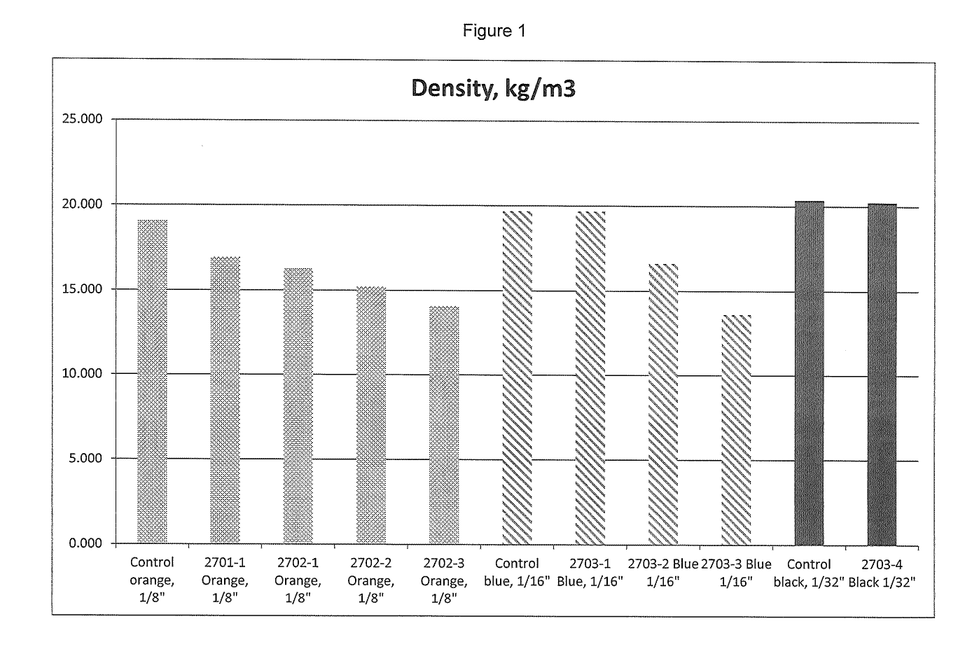

FIG. 1 shows the densities of the resulting foams. The amount of blowing agent was increased to reduce density of the foam. The practical upper limit of the amount of blowing agent was the solubility of the blowing agent in the polymer blend melt. The figure shows that it was possible to reduce the density of the foam below 1 pcf (16.018 kg/m³) relative to the controls which are higher than 1 pcf.

In practice, moving to lower density permits the manufacturer to reduce the amount of polymer used in the foam.

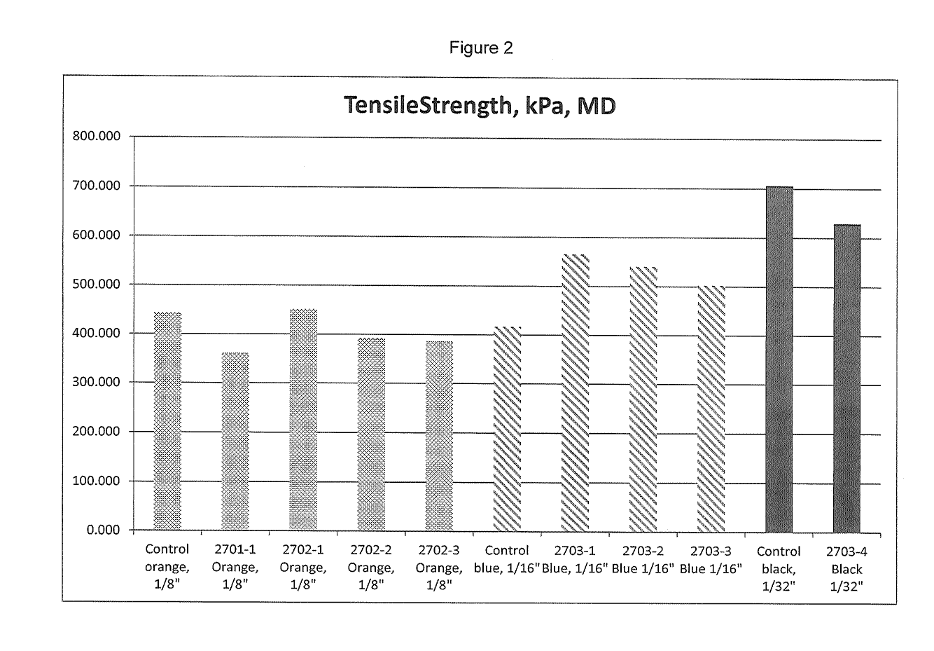

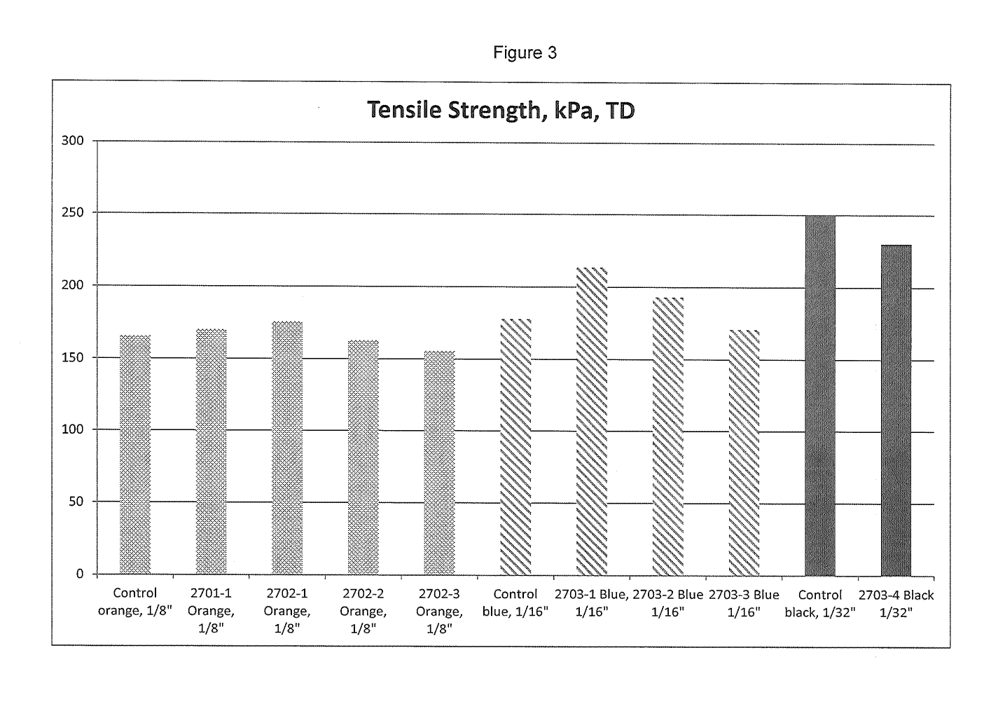

FIGS. 2 and 3 show that the tensile properties of the foams in this disclosure are comparable to those of the prior art.

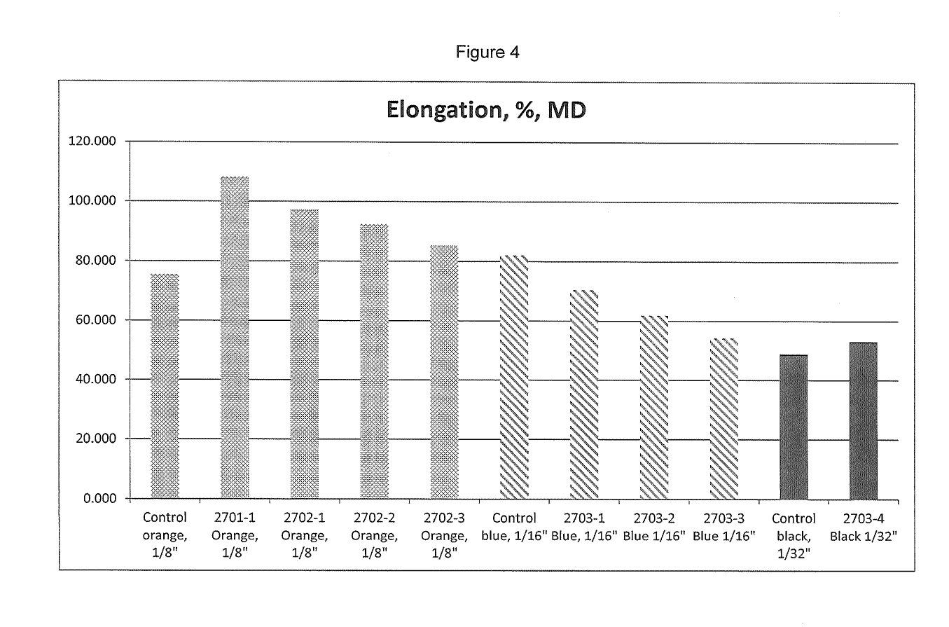

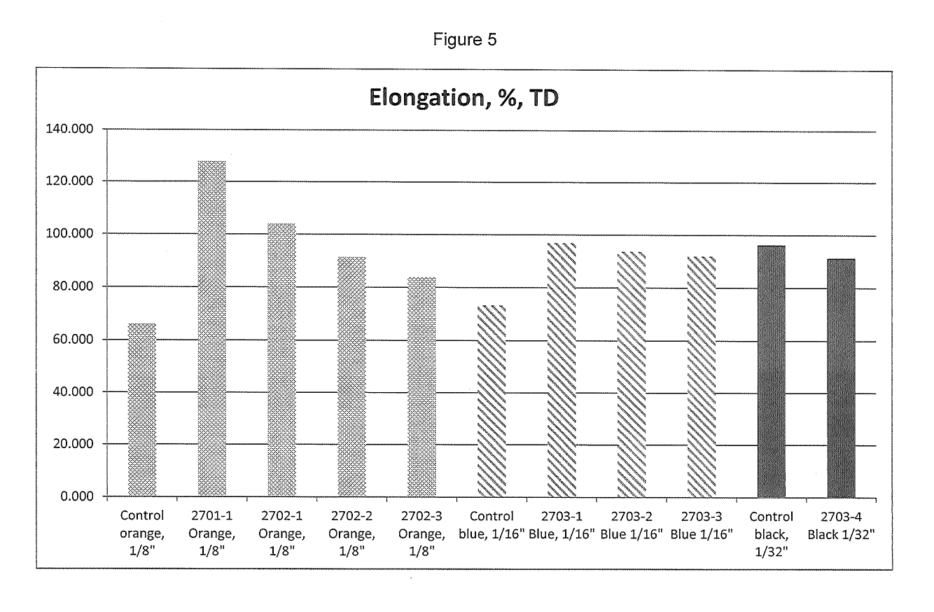

FIGS. 4 and 5 show that the elongation properties of the foams in this disclosure are comparable or better than the foam of the prior art.

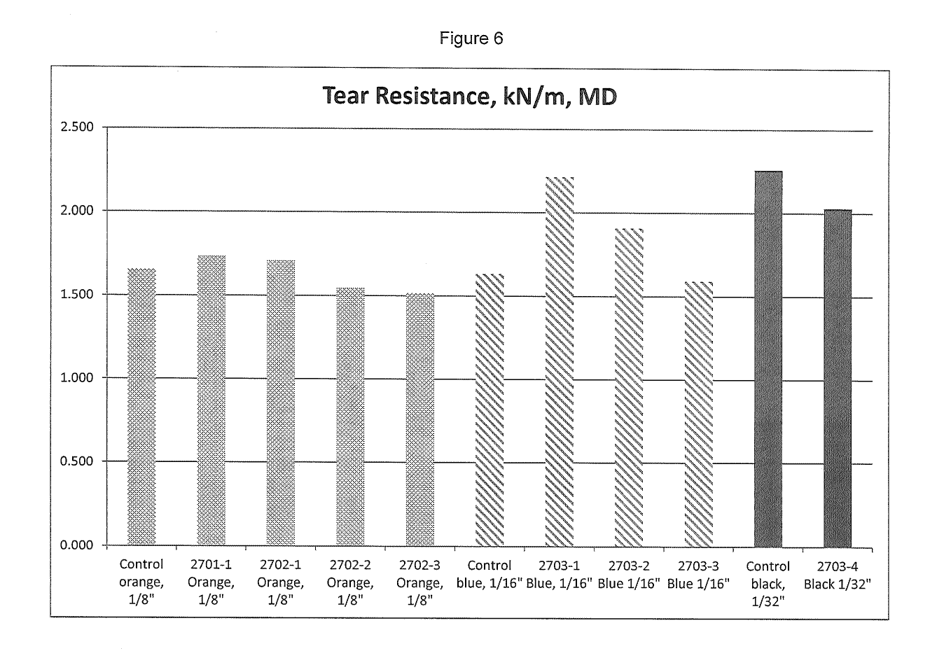

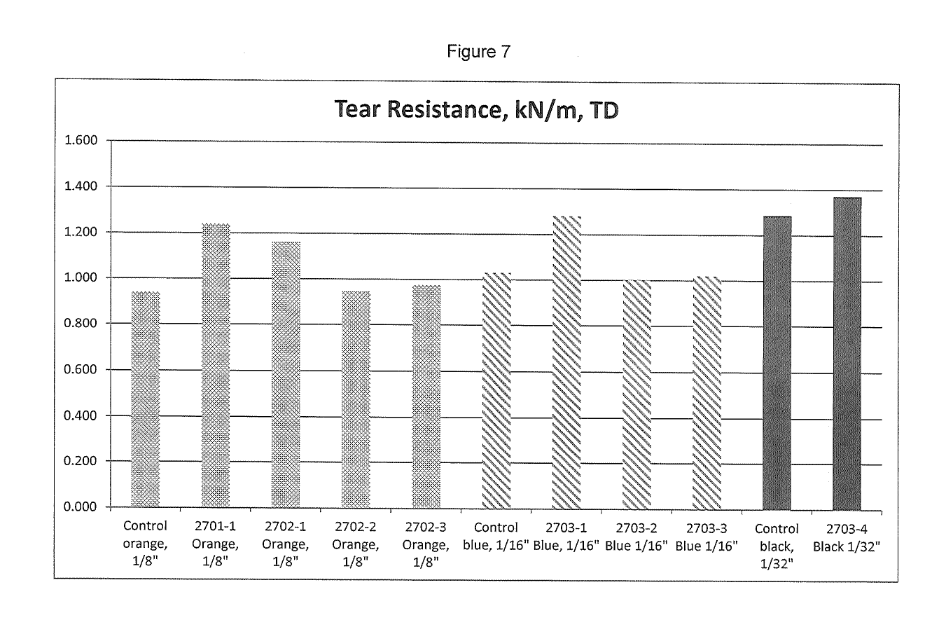

FIGS. 6 and 7 show that the elongation properties of the foams in this disclosure comparable or better than the foam of the prior art.

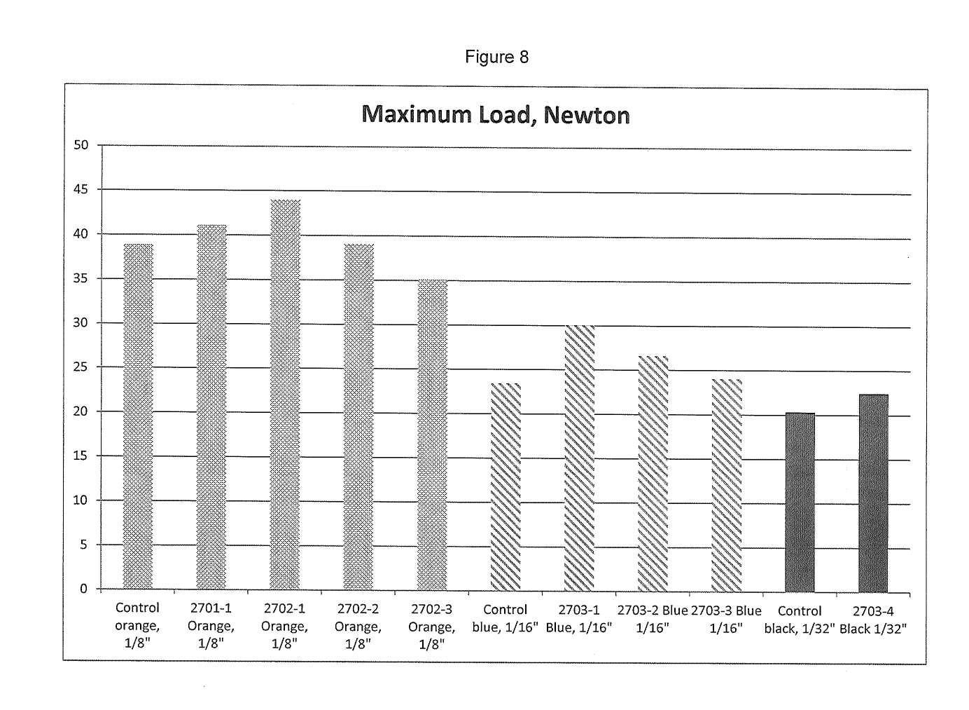

FIG. 8 shows that the puncture resistance of the foams in this disclosure are comparable or superior to the foams of the prior art.

In view of the above, the foams of the present disclosure provide an expanded formulation window for making polyethylene foams of comparable or superior properties.

What is claimed is:

1. A polyethylene foam having a density from about 10 kg/m³ (about 0.6 pounds per cubic foot (pcf)) to about 20 kg/m³ (about 1.25 pcf) comprising a blend of polyethylene polymers comprising:
from about 90 to about 60 weight % of a polyethylene homopolymer prepared in a high pressure process having a density from about 0.915 to about 0.920 g/cc, a melt index from about 0.70 to about 4.5 g/10 min, a maximum melting temperature from (DSC) about 105° C. to about 112° C.; a maximum crystallization temperature from about 95° C. to about 100° C.; a melt strength from about 2.0 to about 7.0 cN as determined by the Rosand Constant Haul Off method; and
from about 10 to about 40 weight % of a single site catalyzed polyethylene copolymer having a density from about 0.915 to about 0.918 g/cc; a melt index from about 0.60 to about 1.2 g/10 min; a maximum melting temperature (DSC) from about 108° C. to about 112° C.; a maximum crystallization temperature (DSC) within 6° C. of that of component i); a flexural modulus between about 206 MPa (about 30,000 psi) and about 620 MPa (about 90,000 psi), and a melt strength from about 1 to about 2 cN as determined by the Rosand Constant Haul Off method;
said blend having a melt strength from about 2.5 to about 8.0 cN as determined by the Rosand Constant Haul Off method, a melt index of less than 10 g/10 minute and a flexural modulus between about 206 MPa (about 30,000 psi) and about 620 MPa (about 90,000 psi); wherein melt index is measured according to ASTM D1238 (2.16 kg load and 190° C.) and density is measured according to ASTM D792.

2. The foam according to claim 1 wherein component ii) is a copolymer of from about 98 to about 85 wt. % of ethylene and the balance one or more C₄₋₈ alpha olefins.

3. The foam according to claim 2, wherein the difference in maximum melting temperature for components i) and ii) is 4° C. or less.

4. The foam according to claim 3, wherein the difference between the maximum crystallization temperature of the component is less than 4° C.

5. The foam according to claim 4, wherein component ii) comprises from about 98 to about 93 weight % of ethylene.

6. The foam according to claim 5, wherein component ii) is an ethylene octene copolymer.

7. The foam according to claim 6 having a density from about 0.8 pcf (about 12.8 kg/m³) to about 1.20 pcf (about 19.2 kg/m³).

8. A blend of polyethylene polymers comprising:
from about 90 to about 60 weight % of a polyethylene homopolymer prepared in a high pressure process having a density from about 0.915 to about 0.920 g/cc, a melt index from about 0.70 to about 4.5 g/10 min, a maximum melting temperature from (DSC) about 105° C. to about 112° C.; a maximum crystallization temperature from about 95° C. to about 100° C.; a melt strength from about 2.0 to about 7.0 cN as determined by the Rosand Constant Haul Off method; and
from about 10 to about 40 weight % of a single site catalyzed polyethylene copolymer having a density from about 0.915 to about 0.918 g/cc; a melt index from about 0.60 to about 1.2 g/10 min; a maximum melting temperature (DSC) from about 108° C. to about 112° C.; a maximum crystallization temperature (DSC) within 6° C. of that of component i); a flexural modulus between about 206 MPa (about 30,000 psi) and about 620 MPa (about 90,000 psi), and a melt strength from about 1 to about 2 cN as determined by the Rosand Constant Haul Off method;
said blend having a melt strength from about 2.5 to about 8.0 cN as determined by the Rosand Constant Haul Off method, a melt index of less than 10 g/10 minute and a flexural modulus between about 206 MPa (about 30,000 psi) and about 620 MPa (about 90,000 psi); wherein melt index is measured according to ASTM D1238 (2.16 kg load and 190° C.) and density is measured according to ASTM D792.

9. A process for making a polyethylene foam according to claim 1 comprising: passing the blend of polyethylene polymers through an extruder at a temperature above the melting point of the blend; injecting from about 2 to about 25 weight %, based on the weight of the blend, of a physical blowing agent into the extruder; foaming the blend as the blend exits the extruder, and; cooling the polyethylene foam; optionally the physical blowing agent is replaced with a chemical blowing agent, wherein about 2 to about 25 weight % of the chemical blowing agent, based on the weight of the blend, is mixed with the blend prior to passing the blend through the extruder or the chemical blowing agent is added to the extruder while the blend is melt processed in the extruder.

10. A process according to claim 9 wherein the physical blowing agent is one or more linear or branched aliphatic hydrocarbon; one or more linear or branched aliphatic hydrocarbon substituted with one or more fluorine, chlorine or bromine atoms, or; a mixture of such hydrocarbons.
